(19) United States
(12) Patent Application Publication
(10) Pub. No.: US 2025/0326435 A1
(43) Pub. Date: Oct. 23, 2025

(54) ELECTRONIC STEERING SYSTEM FOR A VEHICLE

(71) Applicant: Ford Global Technologies, LLC, Dearborn, MI (US)

(72) Inventors: Alexander Ein Waldt, Köln (DE); Oliver Nehls, Düsseldorf (DE); Sergio Codonesu, Aachen (DE); Gerhard Friederich, Bornheim (DE); Miguel Angel Bahena, Saline, MI (US)

(73) Assignee: Ford Global Technologies, LLC, Dearborn, MI (US)

(21) Appl. No.: 19/170,798

(22) Filed: Apr. 4, 2025

(30) Foreign Application Priority Data
Apr. 17, 2024 (DE) 102024110825.8

(51) Int. Cl. B62D 15/02

(52) U.S. Cl. CPC B62D 15/0225

(57) ABSTRACT

Electronic steering systems for vehicles are disclosed. An electronic steering system for a vehicle includes at least one rack having gear teeth, and a wheel sensor assembly configured to sense a movement or a position of the rack, wherein the wheel sensor assembly has a sensor gear meshed with the gear teeth of the rack and a sensor unit coupled to the sensor gear, wherein the sensor is to detect rotation of the sensor gear.

### RELATED APPLICATION

This patent claims priority from DE Patent Application No. 102024110825.8, which was filed on Apr. 17, 2024, and is hereby incorporated herein by reference in its entirety.

### FIELD OF THE DISCLOSURE

This disclosure relates generally to vehicles and, more particularly, to an electronic steering system for a vehicle.

### BACKGROUND

Electronic steering systems are an emerging steering technology in which the mechanical connection between the steering wheel and the vehicle wheel is eliminated and replaced by two actuators: an actuator that generates torque to provide feedback to the driver (on the steering wheel) and a wheel actuator that moves the road wheels to the desired position.

### BRIEF DESCRIPTION OF THE DRAWINGS

FIG. 1 a simplified schematic representation of a vehicle with an electronic steering system according to an example.

FIGS. 2-8 are simplified schematic representations of parts of the electronic steering system according to different examples.

FIG. 9 is a block diagram of an example processing platform including programmable circuitry structured to execute, instantiate, and/or perform the example machine readable instructions and/or perform the example operations disclosed herein.

In general, the same reference numbers will be used throughout the drawing(s) and accompanying written description to refer to the same or like parts. The figures are not necessarily to scale.

### SUMMARY

An electronic steering system for a vehicle includes at least one rack having gear teeth, and a wheel sensor assembly configured to sense a movement or a position of the rack, wherein the wheel sensor assembly has a sensor gear meshed with the gear teeth of the rack and a sensor unit coupled to the sensor gear, and wherein the sensor is to detect rotation of the sensor gear.

A steering system for a vehicle includes at least one rack having gear teeth, and a transmission including a plurality of gears, wherein the gears mesh with the gear teeth of the rack, and a plurality of sensor assemblies configured to sense rotational movement of the plurality of gears.

A steering control system for a vehicle includes a rack having integrally formed gear teeth, and a control device configured to receive position data form a wheel sensor assembly configured to sense a movement or a position of the rack, wherein the wheel sensor assembly has a sensor gear meshed with the integrally formed gear teeth and a sensor unit coupled to the sensor gear, and wherein the sensor unit is to detect rotation of the sensor gear.

### DETAILED DESCRIPTION

For the control of an electronic steering system, the wheel angle (also called track angle) of the steerable vehicle wheels is used to enable appropriate torque feedback to the driver and to check whether the actual wheel angle corresponds to a target wheel angle specification based on a driver's steering input. Previous approaches (e.g. DE 10 2004 042 243 B4, CN 106945715 A, DE 10 2023 117 981 A1 and U.S. Pat. No. 11,780,493 B2) aim to detect the movement of a steering rack by means of a sensor. However, such known examples do not offer a high level of accuracy.

There is therefore a need to eliminate or reduce the disadvantages of known electronic steering systems. In particular, there is a need to create an electronic steering system in which the movement and/or position of the rack can be detected precisely and reliably, but which does not require complex detection techniques.

Examples disclosed herein enable an electronic steering system in which the movement and/or position of the rack can be detected precisely and reliably without requiring complex detection techniques. The electronic steering system includes at least one rack with teeth and a wheel sensor assembly. The wheel sensor assembly is configured to detect a movement or a position of the rack. The wheel sensor assembly has at least one sensor gear and the sensor gear meshes with the teeth of the rack. At least one sensor unit is coupled to the sensor gear. The sensor unit is to detect rotation of the sensor gear.

This creates an electronic steering system in which the wheel sensor assembly interacts directly with the teeth of the rack. The sensor unit detects the movement of the sensor gear, which is caused by the rack. As a result, the movement or the position of the rack can be detected with high precision, and the control system on which the electronic steering system is based can also be carried out with increased precision. In addition, this detection technology leads to a higher configurability of the electronic steering system, as the teeth of the rack can be designed in a variety of ways. It is also advantageous to dispense with specialized sprocket position sensors.

In some examples, the rack is at least indirectly coupled with steerable vehicle wheels, for example the front wheels of a front-axle steering system. The rack can be moved from a reference position, such as a zero position, which causes a steering movement of the steerable vehicle wheels. For example, the steerable vehicle wheels can be turned or angled starting from a straight alignment of the vehicle so that the vehicle can turn. Accordingly, the steerable vehicle wheels have different wheel angles, for example based on a movement of the rack.

To move the rack, the electronic steering system has a wheel actuator. In some examples, the wheel actuator is coupled to the rack. Alternatively, the wheel actuator can be coupled with the steerable vehicle wheels to influence their alignment (wheel angle). To drive the rack, the wheel actuator has an electric motor in some examples.

The gear teeth of the rack can also be used to drive the rack to move the rack from a reference position and thus vary the orientation of the steerable vehicle wheels. This means that, in some examples, the existing gear teeth of the rack can be used to interact with the sensor gear. The gear teeth are also used to couple the sensor gear to enable the position and/or movement of the rack to be precisely detected.

The gear teeth may be implemented using a straight tooth, a helical tooth or a spherical tooth. Thus, the configurability is increased depending on the needs of the specific application. In particular, the straight tooth gearing ensures a low rocking sensitivity of the racks with the teeth of the sensor gear during the meshing process and, thus, increased measurement accuracy.

The gear teeth are mounted on the rack or may be integral to the rack. If the gear teeth are mounted on the rack, a separate assembly including the teeth can be mounted to the rack. This can reduce the overall manufacturing complexity for the rack and the gear teeth compared to an integral design. However, an integral design can increase the structural load-bearing capacity. Optionally, the gear teeth of the rack can include straight, spherical, barrel-shaped or trapezoidal teeth. This increases the configurability of the gear teeth depending on the application-related needs.

In some examples, the sensor gear includes a plastic material or an alloy. This allows the sensor gear to be manufactured in a way that is tailored to application specific needs. For example, the manufacturing complexity can be reduced by including a plastic material. The alloy, for example an aluminum or steel alloy, in turn makes it possible to adapt the radial stiffness of the sensor gear to a radial movement of the rack under load, for example to be able to guarantee a desired accuracy.

The sensor gear has an outer circumference formed by teeth that mesh with the gear teeth of the rack. In some examples, the sensor unit is located in the center (i.e. the axis of rotation of the sensor gear), which increases measurement accuracy. The sensor elements of the sensor units can be, for example, rotation angle sensors or Hall effect sensors. The sensor unit can be directly coupled to the sensor gear in some examples or mounted on a housing in other examples.

In some examples, the wheel sensor assembly has multiple sensor gears that mesh with the gear teeth of the rack. This allows for averaging, which further increases the precision in determining the position and/or movement of the rack. In addition, redundancy is created in the event that, for example, a sensor gear or a sensor unit (sensor element) coupled to a single sensor gear is faulty. Accordingly, several sensor units may be provided, each of which is individually assigned to a sensor gear and is configured to detect rotation of the assigned sensor gear.

If the wheel sensor assembly has several sensor gears, at least two of the sensor gears may have different diameters. This can increase the variability of the wheel sensor arrangement. In addition, it is also ensured that peculiarities during operation caused by a predefined diameter can be checked by a sensor gear with a different diameter. In some examples, the wheel sensor assembly includes a sensor gear drive that encompasses the rack. The sensor gear can then be driven by the gear teeth of the rack.

In some examples, a circumference of the sensor gear is longer than a length along which the rack is movable. This means that the maximum distance traveled along one direction when meshing between the sensor gear and the gear of the steering rack is shorter or equal to the distance that the steering rack would have to travel for the sensor gear to complete a single complete revolution. As a result, a relative angle sensor can be used within the sensor unit. Accordingly, the complexity of the electronic steering system is relatively low. In some examples, the circumference of the sensor gear is shorter than a length along which the rack is movable. In this case, the wheel sensor assembly may include a gearbox or transmission. This can reduce the space needed for assembly, for example by having a smaller diameter of the sensor gear. In some examples, the travel distance of the rack is limited by end stops. This ensures that the rack can only be moved in a limited area. In some examples, the transmission includes the sensor gear and at least one satellite wheel. The wheel sensor assembly can then have at least two sensor units. One sensor unit is coupled to a gear wheel of the transmission. A movement and/or a position of the rack can be determined based on measured values of the sensor units using a Vernier algorithm, for example. The sensor units can also be used to determine the absolute position of the rack. This ensures that the position and/or movement of the rack can be precisely determined.

In one example, the transmission can have a main wheel and at least one satellite wheel. Several satellite wheels can also be provided as an option. At least two gear wheels of the transmission, for example a main wheel and a satellite wheel, can have the same or different diameters.

In some examples, the electronic steering system includes a drive unit with a recirculating ball nut to drive the rack. The recirculating ball nut can also be coupled to the sensor gear, at least indirectly, namely via the rack. For example, an enclosure may be provided that connects the two fixed components. The recirculating ball nut is supported by a ball bearing. This makes the electronic steering system particularly compact. Nevertheless, the sensor gear can be driven by the rack. This can mitigate the need for further adjustments to the rack to drive the sensor gear.

According to an additional aspect, some examples also concern a vehicle with an electronic steering system. The benefits achieved by the electronic steering system described herein are also achieved by the vehicle in a corresponding manner.

For the purposes of disclosure, vehicles may include land vehicles, namely, inter alia, off-road and on-road vehicles such as passenger cars, buses, lorries and other commercial vehicles. Vehicles can be manned or unmanned. Vehicles can be at least partially electrically driven, have an internal combustion engine and/or an electric motor serving as a propulsion system.

The detailed description below, in conjunction with the accompanying drawings, in which the same numbers refer to the same elements, is intended as a description of different examples of the disclosed object and is not intended to represent the only examples. Each example described in this disclosure is intended only as an example or illustration and should not be construed as favored or advantageous over other examples. The illustrative examples contained herein do not claim to be exhaustive and do not limit the claimed subject matter to the exact disclosed forms. Variations of the examples described are readily recognizable to the skilled person and the general principles defined herein can be applied to other examples and applications without departing from the spirit and scope of the examples described. Therefore, the examples described are not limited to the examples shown but have the widest possible scope of application that is compatible with the principles and characteristics disclosed here.

All the features disclosed below in relation to the examples and/or accompanying figures may be combined, alone or in any sub-combination, with features of the aspects of disclosure, including features of preferred examples.

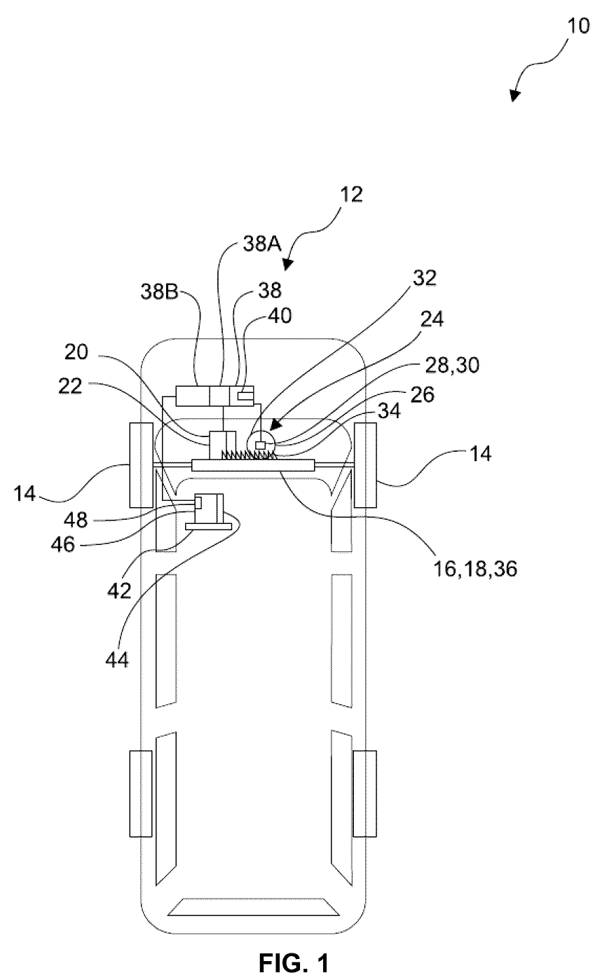

FIG. 1 shows a simplified schematic representation of a vehicle 10 with an electronic steering system 12 according to an example. The vehicle 10 further includes steerable vehicle wheels 14 coupled to a rack 16. In turn, the rack 16 can be moved from a reference position, for example a zero position, which causes a steering movement of the steerable vehicle wheels 14. For example, the steerable vehicle wheels 14 can be deflected starting from a straight alignment of the vehicle 10 so that the vehicle 10 completes a turn. Accordingly, the steerable vehicle wheels 14 have different wheel angles (track angle) with a deflection, for example based on a movement of the rack 16. Although only a front-axle steering assembly 18 is shown here, the vehicle 10 can of course also include a rear-axle steering assembly.

To move the rack 16, the electronic steering system 12 has a wheel actuator 20. In the illustrated example, the wheel actuator 20 is coupled with the rack 16. Alternatively, the wheel actuator 20 can be coupled with the steerable vehicle wheels 14 to be able to influence their alignment (wheel angle).

According to the present example, the wheel actuator 20 has an electric motor 22. The electric motor 22 has winding sets, each including a group of windings. Each winding set is configured so that phase currents are set up in the underlying windings when they are exposed to supply signals, such as phase voltages, which can be used to drive a rotor of the electric motor 22. The rotor can then be coupled to the rack 16 to enable the movement of the rack 16. In general, the electric motor 22 can have more than two winding sets. Typically, each winding set is three-phase, so that the electric motor 22 is also designed in 3n-phase, with n≥1).

The electronic steering system 12 includes a wheel sensor assembly 24 in addition to the position sensors usually mounted on the motor axle of the electric motor 22 to detect the position and/or movement of the rack 16. The position sensors of the electric motor 22 are used to measure the position while driving. In one example, the position sensors can be arranged in such a way that the position of a pinion is detected. The wheel sensor assembly 24 is used to determine the absolute position of the rack 16, for example during a starting process, and/or a relative position to check the plausibility of the position of the rack 16 determined by means of the other position sensors (position sensors of the electric motor or of the pinion). In addition, the wheel sensor assembly 24 ensures redundancy of the other position sensors (position sensors with regard to the electric motor or the pinion) in the event of a fault. This increases the reliability of the position information of the rack 16.

In the illustrated example, the wheel sensor assembly 24 includes a sensor gear 26 and at least one sensor unit 28, which includes at least one sensor element 30. The sensor unit 28 is in communication with the sensor gear 26. According to this example, the sensor unit 28 is directly coupled to the sensor gear 26. The sensor gear 26 has a circumferential length 32 along which are disposed teeth.

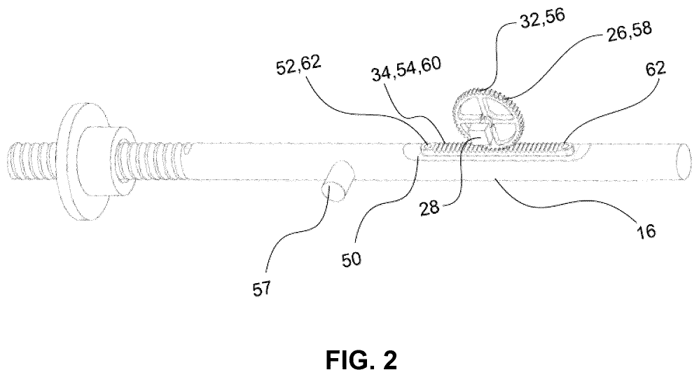

The electronic steering system 12 further includes gear teeth 34, which are located on an outer surface 36 of rack 16. The gear teeth 34 include straight teeth, which means that the rocking sensitivity of the gear teeth 34 through the rack 16 is relatively low. Because the rack 16 can rock laterally, lateral rocking of the rack 16 is reduced, for example by means of the anti-rocking device 57 (FIG. 2) and, thus, the measurement may be less negatively affected. Straight gears, which are designed at right angles to the longitudinal axis of the rack 16, separate the rocking motion from the translational movement and, as a result, are less sensitive compared to helical gears. Thus, measurement inaccuracies can be reduced. The teeth of the circumferential area 32 of the sensor gear 26 mesh with the gear teeth 34 of the rack 16.

The sensor unit 28 is coupled with a control device 38 of the electronic steering system 12. Control device 38 includes at least one data processing device 40. In the illustrated example, the control device 38 has a control device 38A, which is in communication with the wheel actuator 20 and a control device 38B, which is in communication with a steering wheel actuator 44. Both of the control devices 38A, 38B are combined in a single control device 38 in accordance with this example. The individual control devices 38 can each be an integrated component of the respective actuator. Alternatively, the control devices 38 can be external to the respective actuator. If the rack 16 moves, for example based on the electric motor 22 of the wheel actuator 20, this leads to a rotation of the sensor gear 26, which can be detected by the sensor element 30 of the sensor unit 28.

The electronic steering system 12 also includes a steering wheel 42 and a steering wheel actuator 44 in communication with the steering wheel 42, which further includes an electric motor 46. In addition, a steering wheel sensor 48 is in communication with the steering wheel actuator 44. The steering wheel actuator 44 is also coupled with the control device 38. The electric motor 46 can be applied to the 42 steering wheel to provide torque feedback to the driver of the vehicle 10 via the vehicle's lateral guidance.

Based on the measurement data of the steering wheel sensor 48 and the sensor unit 28, the control device 38 can ensure the functionality of the electronic steering system 12 and raise a fault condition to the electronic steering system 12. The detection of the position and/or movement of the rack 16 allows the wheel angle (track angle) of the steerable vehicle wheels 14 to be determined. In this way, the orientation of the steerable vehicle wheels 14 can be determined. For example, based on the measurement data of the sensor unit 28, torque feedback can be guaranteed for the driver at the steering wheel 42. In addition, the control device 38 can be used to check whether the steering input made by the driver to the steering wheel 42 is converted into a movement of the rack 16 as desired, so that a corresponding wheel angle (track angle) of the steerable vehicle wheels 14 is set.

The control device 38 acts as a link between the wheel actuator 20 and the steering wheel actuator 44 to cause a change in the wheel angles of the steerable vehicle wheels 14 of the vehicle 10 depending on the driver's steering specification by means of the steering wheel 42. Further, the control device 38 acts to ensure torque feedback for the driver of the vehicle 10 on the steering wheel 42 based on the wheel angle change of the steerable vehicle wheels 14.

FIGS. 2-8 depict schematic representations of parts of the electronic steering system 12 of FIG. 1 according to different examples. In each case, only the differences are described to mitigate repetition.

Referring to FIG. 2, the rack 16 may have a surface area 50 in which an outer contour of the rack 16 differs from any other outer contour of the rack 16. For example, the surface area 50 can be a flattened area. In the surface area 50, the gear teeth 34 may then be arranged. This ensures that the gear teeth 34 do not cause the dimensions of the rack 16 to be increased. In particular, the surface area 50 may be designed in such a way that the gear teeth 34 are enclosed by an aligned outer contour of the rack 16, which includes a portion of the rack 16 outside the surface area 50. The gear teeth 34 may be coupled with the rack 16, for example, by means of appropriate fasteners 52, for example, it may be mounted on it. This allows the separate production of the gear teeth 34, which means that the manufacturing complexity is relatively low.

The gear teeth 34 include a plurality of teeth 54, which in the illustrated example are designed according to a straight tooth design. The sensor gear 26 has a circumferential area 32, which is formed by teeth 56. The teeth 56 of the sensor gear 26 may mesh with the teeth 54 of the gear teeth 34. The sensor unit 28 is at least indirectly coupled to the sensor gear 26, for example if the magnetic field strength change measurement is used as a measuring principle, but alternatively directly, for example in mechanical measurement techniques. The sensor unit 28 is located in the center of the sensor gear 26 in accordance with the axis of rotation of the sensor gear 26.

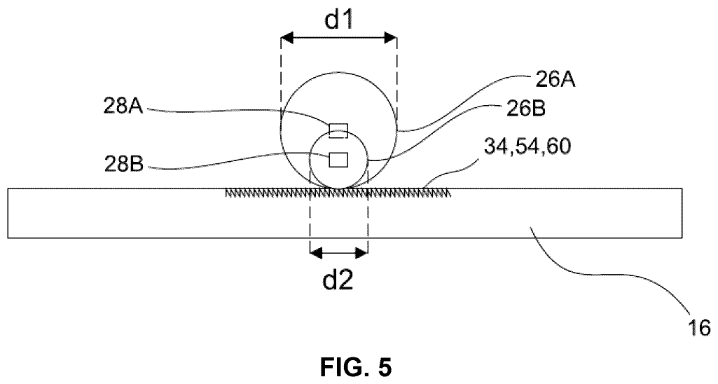

The rack 16 is equipped with an anti-rotation device 57 which prevents rotation of the rack 16 around its circumference by ensuring a tight fit of the rack 16 with a correspondingly designed and shaped external component (not shown). As a result, the rocking (e.g. lateral rocking or movement) of the rack 16 is minimized along its circumferential face. The tight fit based on the anti-rotation device 57 ensures that the gear teeth 34 can include any type of teeth, for example, a helical gear teeth or crowned gear teeth. However, if small rocking movements of the rack 16 remain along the circumferential surface, the straight toothing ensures maximum measurement accuracy. Even if the anti-rotation device 57 of FIG. 2 is not shown in relation to the examples shown in FIGS. 5-8, these examples of the rack 16 may also have a corresponding anti-rotation device 57.

In the illustrated example, the circumference 58 of the sensor gear 26 is such that the length of the gear teeth 34 is shorter than the distance covered by the sensor gear 26 over the rack 16 in a single revolution. This means that the travel 60 of the gear teeth 34 between opposing end stops 62 is shorter than the distance covered by the sensor gear 26 in a single revolution.

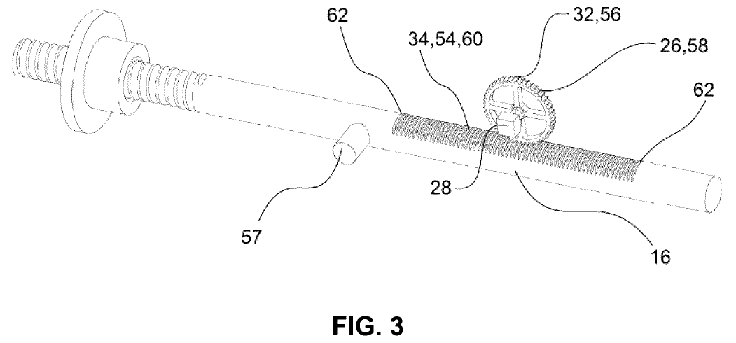

In the example illustrated in FIG. 3, the gear teeth 34 may also be integrally formed with the rack 16. This means that fasteners 52 can be eliminated. In addition, the structural stability of the gear assembly 34 is particularly high as a result. The sensor gear 26 then meshes with the teeth 56 directly on the rack 16.

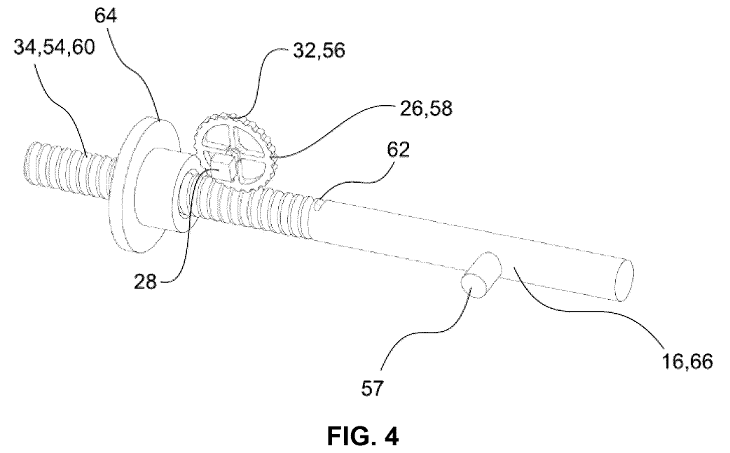

In the example illustrated in FIG. 4, existing gear teeth can also be used as gear teeth 34. For example, the wheel actuator 20 may have a recirculating ball nut 64 by means of which the rack 16 can be moved. The recirculating ball nut 64 is fixed with the sensor gear 26 to form an indirect, fixed mechanical coupling carried out via the rack 16. A housing (not shown) may be provided that connects the two fixed components (i.e. the recirculating ball nut 64 and the sensor gear 26). The recirculating ball nut 64 is supported by a ball bearing. The gear assembly 34 of the rack 16 drives the sensor gear 26.

In the embodiment illustrated in FIG. 5, the wheel sensor assembly 24 may further include several sensor gears 26, 26A, 26B. According to the illustrated example, the different sensor gears 26A, 26B are coupled to the same gear teeth 34 and mesh parallel to each other with the gear teeth 34. The sensor units 28 are each coupled separately with the control device 38. According to this example, the different sensor gears 26A, 26B have different diameters d1, d2. This allows the control device 38 to check whether differences are caused by a specific diameter. In addition, redundancy is created.

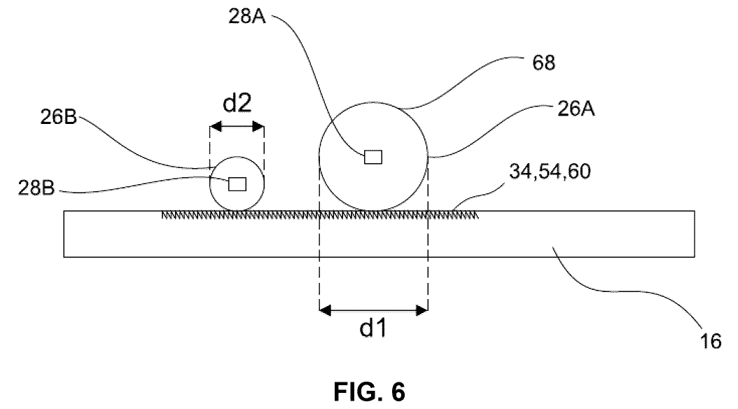

In the example illustrated in FIG. 6, the multiple sensor gears 26A, 26B may also be arranged sequentially with respect to the gear teeth 34. This means that they mesh with different areas of the gear teeth 34, and are thus moved one after the other, measured at the absolute position of the gear teeth 34. Alternatively, several gear teeth 34 can be provided with the sensor gears 26A, 26B (not shown).

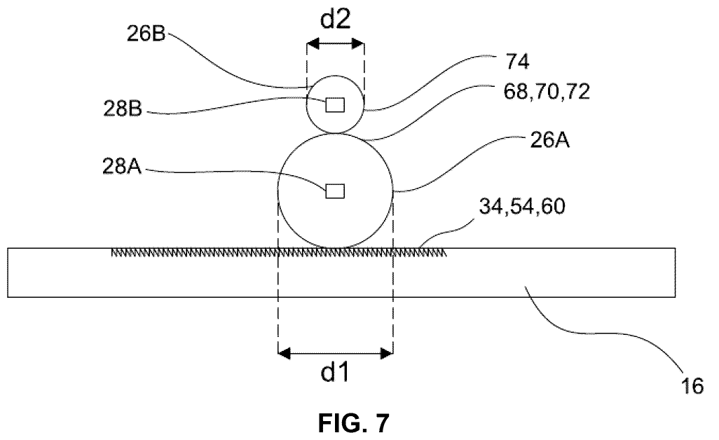

In the example illustrated in FIG. 7, the wheel sensor assembly 24 may further include a transmission 68. The transmission 68 has at least several gears 70. The gears 70 can be formed by corresponding sensor gears 26A, 26B. For example, the transmission 68 can have a main wheel 72 and at least a satellite wheel 74. While the main wheel 72 meshes with the gear teeth 34, the satellite wheel 74 meshes with the main wheel 72.

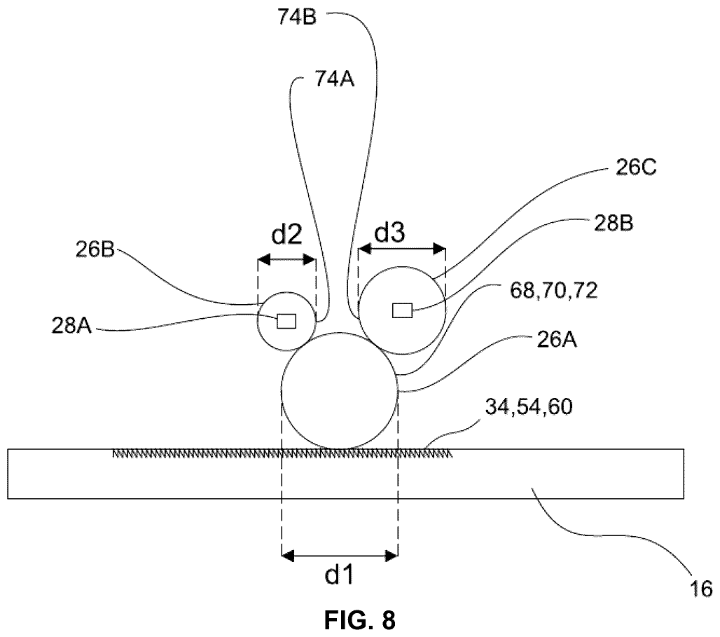

In the example illustrated in FIG. 8, the wheel sensor assembly 24 can further include a transmission or gearbox 68 with a main wheel 72 and several satellite wheels 74A, 74B. The different satellite wheels 74A, 74B can have the same or different diameters d2, d3. As a result, a demand-based ratio of the transmission 68 can be adjusted. In this case, the main wheel 72 does not need to have a sensor unit 28.

Specific embodiments disclosed herein use circuits (e.g., one or more circuits) to implement standards, protocols, methods, or technologies disclosed here, to functionally couple two or more components, to generate information, to process information, to analyze information, to generate signals, to encode/decode signals, to convert signals, to transmit and/or receive signals, to control other devices, etc. Circuits of any kind can be used.

In an embodiment, a circuit such as the control device includes, but is not limited to, one or more data processing devices such as a processor (e.g., a microprocessor), a central processing unit (CPU), a digital signal processor (DSP), an application-specific integrated circuit (ASIC), a field-programmable gate array (FPGA), a system on a chip (SoC), or similar, or any combination thereof, and can contain discrete digital or analog devices. circuit elements or electronics or combinations thereof. In an embodiment, circuit includes hardware circuit implementations (e.g., implementations in analog circuits, implementations in digital circuits, and the like, and combinations thereof).

In an embodiment, circuits include combinations of circuits and computer program products with software or firmware instructions stored on one or more computer-readable memories that work together to cause a device to execute one or more of the protocols, procedures, or technologies described herein. In an embodiment, circuit engineering includes circuits, such as microprocessors or parts of microprocessors, that require software, firmware, and the like to operate. In an embodiment, the circuits comprise one or more processors or parts thereof and the associated software, firmware, hardware, and the like.

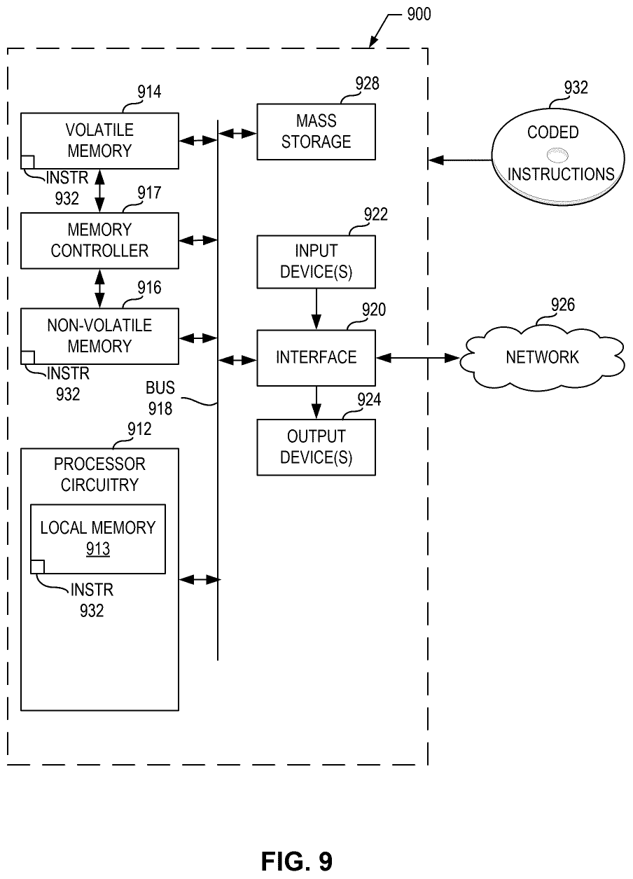

FIG. 9 is a block diagram of an example programmable circuitry platform 900 structured to execute and/or instantiate machine-readable instructions to implement the electronic steering system 12 and/or its various components disclosed herein. The programmable circuitry platform 900 can be, for example, a control device, an ECU, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, VPUs, DSPs, and/or microcontrollers from any desired family or manufacturer. The programmable circuitry 912 may be implemented by one or more semiconductor based (e.g., silicon based) devices.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a button, a touchscreen, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIG. 3, may be stored in the mass storage device 928, in the volatile memory 914, in the non-volatile memory 916, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed that enable increased accuracy, reliability, and reduced complexity of electronic steering systems for vehicles. Disclosed systems, apparatus, articles of manufacture, and methods are accordingly directed to one or more improvement(s) in the operation of a machine such as a computer or other electronic and/or mechanical device.

It is noted that this patent claims priority from Patent Application Number DE 102024110825.8, which was filed on Apr. 17, 2024. and is hereby incorporated by reference in its entirety.

Example 1 includes an electronic steering system for a vehicle including at least one rack having gear teeth and a wheel sensor assembly configured to sense a movement or a position of the rack, wherein the wheel sensor assembly has a sensor gear meshed with the gear teeth of the rack and a sensor unit coupled to the sensor gear, wherein the sensor unit is to detect rotation of the sensor gear.

Example 2 includes the electronic steering system of example 1, wherein a circumference of the sensor gear is longer than a length along which the rack is movable.

Example 3 includes the electronic steering system of example 1, wherein a circumference of the sensor gear is shorter than a length along which the rack is movable.

Example 4 includes the electronic steering system of example 1, wherein the wheel sensor assembly includes a plurality of sensor gears, and wherein at least two of the sensor gears include respective sensor units.

Example 5 includes the electronic steering system of example 1, wherein the sensor gear is a first sensor gear of a plurality of sensor gears operatively coupled to the gear teeth of the rack.

Example 6 includes the electronics teering system of example 5, wherein the first sensor gear and a second sensor gear of the plurality of sensor gears have different diameters.

Example 7 includes the electronic steering system of example 6, wherein the first sensor gear is meshed with the gear teeth of the rack and the second sensor gear is meshed with the first sensor gear.

Example 8 includes the electronic steering system of example 6, wherein the first and second sensor gears are meshed with the gear teeth of the rack.

Example 9 includes the electronic steering system of example 1, further including a drive unit with a recirculating ball nut for driving the rack, and wherein the recirculating ball nut is operatively coupled to the sensor gear via the rack.

Example 10 includes the electronic steering system of example 1, wherein the gear teeth are integral to the rack.

Example 11 includes the electronic steering system of example 1, wherein the gear teeth are straight, spherical, barrel-shaped or trapezoidal.

Example 12 includes the electronic steering system of example 1, wherein the gear teeth include a plastic material or an alloy.

Example 13 includes the electronic steering system of example 1, wherein the sensor gear includes a plastic material or an alloy.

Example 14 includes a steering system for a vehicle including at least one rack having gear teeth, and a transmission including a plurality of gears, wherein the plurality of gears are meshed with the gear teeth of the rack and a plurality of sensor assemblies configured to sense rotational movement of the plurality of gears.

Example 15 includes the steering system of example 14, wherein a circumference of the plurality of gears is longer than a length along which the rack is movable.

Example 16 includes the steering system of example 14, wherein a circumference of the plurality of gears is shorter than a length along which the rack is movable.

Example 17 includes a steering control system for a vehicle including a rack having integrally formed gear teeth, and a control device configured to receive position data from a wheel sensor assembly configured to sense a movement or a position of the rack, wherein the wheel sensor assembly has a sensor gear meshed with the integrally formed gear teeth and a sensor unit coupled to the sensor gear, wherein the sensor unit is to detect rotation of the sensor gear.

Example 18 includes the steering control system of example 17, further including a steering wheel and a steering wheel sensor to generate position data of the steering wheel.

Example 19 includes the steering control system of example 18, wherein the control device is further configured to compare the position data of the steering wheel and the position data of the wheel sensor assembly.

Example 20 includes the steering control system of example 19, wherein the control device is further configured to, after identifying a difference between the position data of the steering wheel and the position data of the wheel sensor assembly, set a fault condition.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An electronic steering system for a vehicle comprising:
at least one rack having gear teeth; and
a wheel sensor assembly configured to sense a movement or a position of the rack, wherein the wheel sensor assembly has a sensor gear meshed with the gear teeth of the rack and a sensor unit coupled to the sensor gear, wherein the sensor unit is to detect rotation of the sensor gear.

2. The electronic steering system of claim 1, wherein a circumference of the sensor gear is longer than a length along which the rack is movable.

3. The electronic steering system of claim 1, wherein a circumference of the sensor gear is shorter than a length along which the rack is movable.

4. The electronic steering system of claim 1, wherein the wheel sensor assembly includes a plurality of sensor gears, and wherein at least two of the sensor gears include respective sensor units.

5. The electronic steering system of claim 1, wherein the sensor gear is first sensor gear of a plurality of sensor gears operatively coupled to the gear teeth of the rack.

6. The electronic steering system of claim 5, wherein the first sensor gear and a second sensor gear of the plurality of sensor gears have different diameters.

7. The electronic steering system of claim 6, wherein the first sensor gear is meshed with the gear teeth of the rack and the second sensor gear is meshed with the first sensor gear.

8. The electronic steering system of claim 6, wherein the first and second sensor gears are meshed with the gear teeth of the rack.

9. The electronic steering system of claim 1, further including a drive unit with a recirculating ball nut for driving the rack, and wherein the recirculating ball nut is operatively coupled to the sensor gear via the rack.

10. The electronic steering system of claim 1, wherein the gear teeth are integral to the rack.

11. The electronic steering system of claim 1, wherein the gear teeth are straight, spherical, barrel-shaped or trapezoidal.

12. The electronic steering system of claim 1, wherein the gear teeth include a plastic material or an alloy.

13. The electronic steering system of claim 1, wherein the sensor gear includes a plastic material or an alloy.

14. A steering system for a vehicle comprising:
at least one rack having gear teeth; and
a transmission including:
a plurality of gears, wherein the plurality of gears are meshed with the gear teeth of the rack; and
a plurality of sensor assemblies configured to sense rotational movement of the plurality of gears.

15. The steering system of claim 14, wherein a circumference of the plurality of gears is longer than a length along which the rack is movable.

16. The steering system of claim 14, wherein a circumference of the plurality of gears is shorter than a length along which the rack is movable.

17. A steering control system for a vehicle comprising:
a rack having integrally formed gear teeth; and
a control device configured to receive position data from a wheel sensor assembly configured to sense a movement or a position of the rack, wherein the wheel sensor assembly has a sensor gear meshed with the integrally formed gear teeth and a sensor unit coupled to the sensor gear, wherein the sensor unit is to detect rotation of the sensor gear.

18. The steering control system of claim 17, further including:
a steering wheel; and
a steering wheel sensor to generate position data of the steering wheel.

19. The steering control system of claim 18, wherein the control device is further configured to compare the position data of the steering wheel and the position data of the wheel sensor assembly.

20. The steering control system of claim 19, wherein the control device is further configured to, after identifying a difference between the position data of the steering wheel and the position data of the wheel sensor assembly, set a fault condition.
